(19) United States
(12) Patent Application Publication
(10) Pub. No.: US 2005/0152251 A1
(43) Pub. Date: Jul. 14, 2005

(54) Method and apparatus for recording check data of file system on recording medium

(75) Inventor: Mitsuo Harumatsu, Yokoham-shi (JP)

Correspondence Address: LOUIS WOO;LAW OFFICE OF LOUIS WOO, 717 NORTH FAYETTE STREET, ALEXANDRIA, VA, 22314, US

(73) Assignee: VICTOR COMPANY OF JAPAN, LTD., YOKOHAMA (JP)

(21) Appl. No.: 11/024,417

(22) Filed: Dec. 30, 2004

(30) Foreign Application Priority Data
Jan. 8, 2004 (JP) 2004-002591

(51) Int. Cl. G11B 5/09

(52) U.S. Cl. 369/53.2; 369/47.21

(57) ABSTRACT

A recording medium has a data region, a management region, and a directory region. The data region is used to store file data. The management region is used to store management data representing which portion of the data region is used by the file data. The directory region is used to store file management information about the file data in the data region. The file data, the management data, and the file management information are governed by a file system. According to a predetermined function, new management data is converted into first check data representative of a uniquely decided value. According to the predetermined function, new file management information is converted into second check data representative of a uniquely decided value. The first check data and the second check data are recorded on a specified area in the recording medium.

### BACKGROUND OF THE INVENTION

1. Field of the Invention

This invention relates to a method and an apparatus for recording check data of a file system on a recording medium. This invention particularly relates to a method and an apparatus for recording, on a removable recording medium, check data which can be used to detect whether or not contents data stored in the removable recording medium has been altered in a file system prescribing a data management structure and a data management way for data recording and data reproduction. This invention also relates to a method and an apparatus for detecting alteration of data in a file system. This invention particularly relates to a method and an apparatus for detecting whether or not data stored in a removable recording medium has been altered in a file system prescribing a data management structure and a data management way for data recording and data reproduction.

2. Description of the Related Art

Some portable AV (audio visual) apparatuses such as a digital still camera and a digital video camera can use removable general-purpose recording mediums. Examples of the removable general-purpose recording mediums are a memory card, a card-shaped hard disc drive (HDD), a writable CD (compact disc), and a writable DVD (digital versatile disc).

In general, a removable general-purpose recording medium can be detached from a related portable AV apparatus before being connected with a personal computer (a PC). While the recording medium remains connected with the PC, data can be read from and written into the recording medium by the PC.

In many cases, data stored in a card-shaped recording medium is managed according to a de facto standard FAT file system such as FAT12, FAT16, or FAT32. Here, FAT is short for File Allocation Table. The standard file system, ISO 9660, published by the International Organization for Standardization, is designed as a standard logical format for a CD-ROM. UDF (Universal Disk Format) is a general-purpose file format for optical storages. Generally, ISO 9660 or UDF is used for management of data in a writable CD such as a CD-R or a CD-RW. Generally, UDF is also used for management of data in a writable DVD such as a DVD-R, a DVD-RW, a DVD+R, a DVD+RW, or a DVD-RAM.

There are portable apparatuses containing nonvolatile memories instead of removable recording mediums. In some of such portable apparatuses, the USB (Universal Serial Bus) Mass Storage Class enables internal nonvolatile memories to be used as removable recording mediums connected with PCs.

The FAT file system, the ISO 9660 file system, the UDF file system, and the USB Mass Storage Class file system are of general-purpose. Thus, data stored in a recording medium and managed according to one of these file systems can be freely altered via a PC without installing a special driver thereon.

A portable apparatus encounters unexpected alteration of data in a recording medium which is caused by data change operation through a PC. Examples of the data change operation are altering recorded data, deleting recorded data, and writing new data. In the case where data management in the portable apparatus is prescribed only by a file system, there occurs no problem since the portable apparatus, the recording medium, and the PC are in harmony with each other in file system.

On the other hand, in the case where the portable apparatus has its own management information about the recorded contents in the recording medium, its own management information and the file system may be out of harmony with each other. For example, in the case where the portable apparatus has a management table for a list of the recorded contents in the recording medium, new contents added by the PC can not be reflected in the management table. Typically, the management table indicates the creation dates, update dates, and sizes of the recorded contents. When the recorded contents are altered via the PC, the update dates and sizes indicated by the management table in the portable apparatus remain the same and are not renewed accordingly. Thus, in this case, the updated dates and sizes indicated by the management table go inconsistent with the altered recorded contents.

In the case where the portable apparatus manages information about the physical allocation of files in the recording medium, when the PC uses a file relocating tool such as “scan disk”, the physical allocation of the files is changed although their logical contents remain the same so that the physical-allocation information may go wrong.

Japanese patent application publication number 11-134236 (1999) discloses an image data processing apparatus including a memory loaded with image data. In the apparatus of Japanese application 11-134236, when the image data in the memory is processed into a file, a file control block (an FCB) is generated for the file. The FCB has data representing the size of the file, and data representing a checksum of the file. The file checksum data and the file size data in the FCB are redundant data for file fault detection. In general, there are plural file control blocks assigned to files respectively.

The apparatus in Japanese application 11-134236 includes a file check system which operates as follows. When the supply of power to the apparatus is started, a decision is made as to whether a file to be checked is present or absent. In the presence of a file to be checked, the size and checksum of the file are derived from the related FCB. The file is accessed to measure the actual size thereof and to calculate the actual checksum thereof. The FCB file size and the actual file size are compared with each other. The FCB file checksum and the actual file checksum are compared with each other. When the FCB file size and the actual file size are different, or when the FCB file checksum and the actual file checksum are different, the file is concluded to be faulty. On the other hand, when the FCB file size and the FCB file checksum are equal to the actual file size and the actual file checksum respectively, the file is concluded to be normal. The faulty file is registered in a list of faulty files. The detection of the faulty file is indicated on a display in an operation console of the apparatus. When specified conditions are satisfied, the faulty file is deleted.

In the apparatus of Japanese application 11-134236, when redundant data for file fault detection is changed in accordance with alteration of data in a related file, the redundant data can not be used for detecting whether or not the data in the file has been altered. Since the redundant data is generated from the data in the file, the number of steps of generating the redundant data and the processing time spent for the generation of the redundant data depend on the size of the file and are thus variable.

In the case where the file check procedure in Japanese application 11-134236 is implemented for each file upon the mounting or unmounting of a file system, the time spent to start up or end the file system is longer as the amount of data in the files increases. Especially, a gigabyte-order big-size file, for example, a file having AV stream data, requires an extremely long time to be taken to generate related redundant data and implement the file check procedure.

In the apparatus of Japanese application 11-134236, the file check procedure is implemented file by file. Thus, the total time taken by the file check procedures lengthens as the number of files increases. The file size and the file checksum represented by the redundant data in each FCB are relatively simple evaluation values. Therefore, the file size and the file checksum seem insufficient parameters for detecting whether or not the data in the related file has been altered.

### SUMMARY OF THE INVENTION

It is a first object of this invention to provide a method of recording, on a removable recording medium, check data which can be used to easily and quickly detect alteration of contents data in a file system.

It is a second object of this invention to provide an apparatus for recording, on a removable recording medium, check data which can be used to easily and quickly detect alteration of contents data in a file system.

It is a third object of this invention to provide a simple method of detecting alteration of data in a file system.

It is a fourth object of this invention to provide a simple apparatus for detecting alteration of data in a file system.

It is a fifth object of this invention to provide a method of quickly detecting alteration of data in a file system.

It is a sixth object of this invention to provide an apparatus for quickly detecting alteration of data in a file system.

A first aspect of this invention provides a method of recording check data on a recording medium having a data region, a management region, and a directory region. The data region is for storing file data. The management region is for storing management data representing which portion of the data region is used by the file data. The directory region is for storing file management information about the file data in the data region. The file data, the management data, and the file management information are governed by a file system. The method comprises the steps of converting management data into first check data representative of a uniquely decided value according to a predetermined function; converting file management information into second check data representative of a uniquely decided value according to the predetermined function; and recording the first check data and the second check data on a specified area in the recording medium.

A second aspect of this invention is based on the first aspect thereof, and provides a method wherein the file system is a FAT file system, and the management region is a FAT region.

A third aspect of this invention is based on the first aspect thereof, and provides a method wherein the file system is a UDF file system, and the management region is a space bit map region.

A fourth aspect of this invention is based on the first aspect thereof, and provides a method wherein the specified area includes at least one of (1) a master boot record region, (2) a boot sector, (3) a gap between partitions, and (4) a hidden sector.

A fifth aspect of this invention provides a method of detecting alteration of file data stored in a recording medium and governed by a file system. File management information about the file data is recorded on the recording medium according to the file system. The method comprises the steps of reading out check data from a specified area in the recording medium; converting the file management information into reference check data representative of a uniquely decided value according to a predetermined function; and comparing the read-out check data and the reference check data to detect whether or not the file data in the recording medium has been altered.

A sixth aspect of this invention is based on the fifth aspect thereof, and provides a method wherein the recording medium has a data region, a management region, and a directory region. The data region stores the file data. The management region stores management data representing which portion of the data region is used by the file data. The directory region stores management information about the file data in the data region. The management data in the management region and the management information in the directory region compose the file management information. The read-out check data has first and second segments. The converting step comprises converting the management data into a first segment of the reference check data which is representative of a uniquely decided value according to the predetermined function, and converting the management information into a second segment of the reference check data which is representative of a uniquely decided value according to the predetermined function. The comparing step comprises comparing the first segment of the read-out check data and the first segment of the reference check data to detect whether or not the file data in the recording medium has been altered.

A seventh aspect of this invention is based on the sixth aspect thereof, and provides a method wherein the comparing step comprises comparing the second segment of the read-out check data and the second segment of the reference check data to detect whether or not the file data in the recording medium has been altered after the comparison between the first segment of the read-out check data and the first segment of the reference check data.

An eighth aspect of this invention is based on the sixth aspect thereof, and provides a method wherein the file system is a FAT file system, and the management region is a FAT region.

A ninth aspect of this invention is based on the sixth aspect thereof, and provides a method wherein the file system is a UDF file system, and the management region is a space bit map region.

A tenth aspect of this invention is based on the fifth aspect thereof, and provides a method wherein the specified area includes at least one of (1) a master boot record region, (2) a boot sector, (3) a gap between partitions, and (4) a hidden sector.

An eleventh aspect of this invention provides an apparatus for recording check data on a recording medium having a data region, a management region, and a directory region. The data region is for storing file data. The management region is for storing management data representing which portion of the data region is used by the file data. The directory region is for storing file management information about the file data in the data region. The file data, the management data, and the file management information are governed by a file system. The apparatus comprises means for converting management data into first check data representative of a uniquely decided value according to a predetermined function; means for converting file management information into second check data representative of a uniquely decided value according to the predetermined function; and means for recording the first check data and the second check data on a specified area in the recording medium.

A twelfth aspect of this invention provides an apparatus for detecting alteration of file data stored in a recording medium and governed by a file system. File management information about the file data is recorded on the recording medium according to the file system. The apparatus comprises means for reading out check data from a specified area in the recording medium; means for converting the file management information into reference check data representative of a uniquely decided value according to a predetermined function; and means for comparing the read-out check data and the reference check data to detect whether or not the file data in the recording medium has been altered.

### BRIEF DESCRIPTION OF THE DRAWINGS

FIG. 1 is a flowchart of a first segment of a computer program in an embodiment of this invention.

FIG. 2 is a flowchart of a second segment of the computer program.

FIG. 3 is a diagram of the structure of a FAT file system.

FIG. 4 is a block diagram of a computer apparatus or a computer-based AV apparatus in the embodiment of this invention.

FIG. 5 is a diagram of a removable recording medium and a check data generation circuit in the apparatus of FIG. 4.

FIG. 6 is a diagram of an example of the relation between file management information and extents in the removable recording medium which store the file management information.

FIG. 7 is a diagram of a portion of the removable recording medium which contains specified areas assigned to check data.

### DETAILED DESCRIPTION OF THE INVENTION

An embodiment of this invention is provided as a combination of a computer program and a computer apparatus or a computer-based AV (audio visual) apparatus which operates in accordance with the computer program, and which includes a CPU, a storage unit or a memory storing the computer program, another storage unit or another memory, a drive for a removable recording medium, and a check data generation circuit. The computer apparatus or the computer-based AV apparatus is also referred to as the present apparatus. The program storage unit may be in common with the other storage unit. The program memory may be in common with the other memory. The removable recording medium can be inserted into and ejected from the drive. In general, the removable recording medium stores a file or a file group (a group of files) managed by a file system. The computer program has a first segment and a second segment.

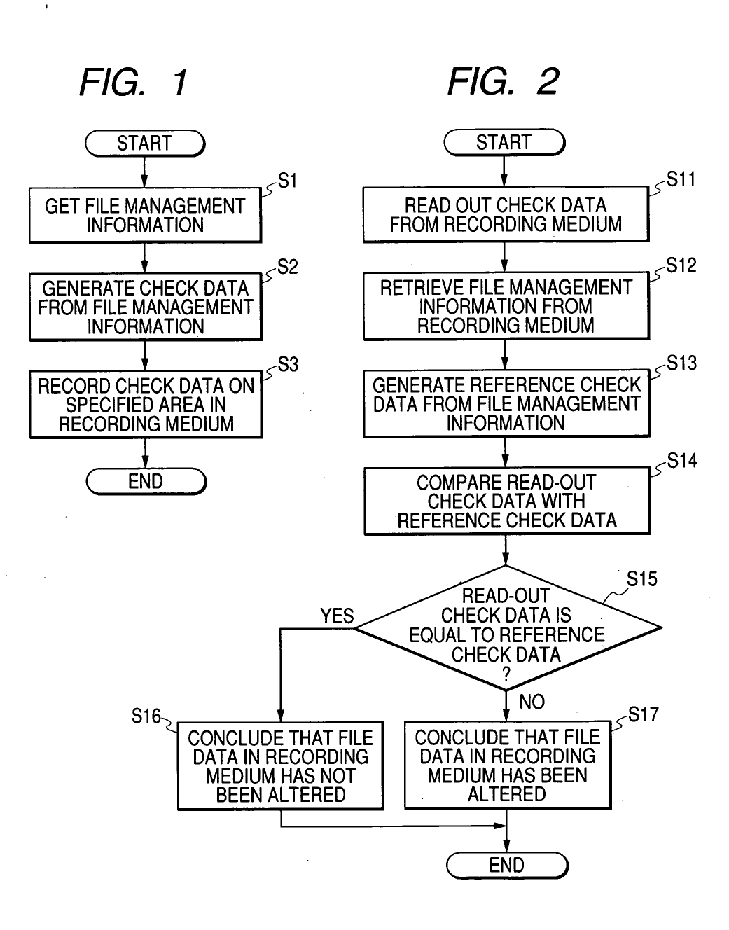

FIG. 1 is a flowchart of the first segment of the computer program. In the case where a removable recording medium remains in the drive within the present apparatus, the first segment of the computer program is started when check data is required to be recorded on the removable recording medium, when check data in the removable recording medium is required to be updated into consistency with the current contents of a file or a file group in the removable recording medium, or when alteration of a file or a file group in the removable recording medium is detected.

As shown in FIG. 1, a first step S1 of the program segment gets file management information which relates to the current contents of a file or a file group in a removable recording medium within the drive. For example, at a previous stage, the file management information has been newly generated or has been read out from the removable recording medium.

A step S2 following the step S1 converts the file management information into check data representative of a uniquely decided value according to a predetermined function (a specified function). Specifically, the step S2 activates the check data generation circuit to implement the conversion of the file management information into the check data. In general, the check data is composed of pieces originating from respective pieces of the file management information.

A step S3 subsequent to the step S2 controls the drive to record the check data on a specified area in the removable recording medium. Preferably, the specified area is separate from the ordinary area in the removable recording medium which is under the management by the file system. Thus, in this case, the check data in the removable recording medium is out of the management by the file system. It should be noted that the specified area may be within the ordinary area in the removable recording medium. After the step S3, the current execution cycle of the program segment ends.

FIG. 2 is a flowchart of the second segment of the computer program. The second segment of the computer program is started when a removable recording medium is inserted into the drive within the present apparatus.

As shown in FIG. 2, a first step S11 of the program segment controls the drive to read out check data from the specified area in the removable recording medium.

A step S12 following the step S11 controls the drive to retrieve file management information from the file-system management area of the removable recording medium. The retrieved file management information relates to the current contents of a file or a file group in the removable recording medium.

A step S13 subsequent to the step S12 converts the retrieved file management information into check data representative of a uniquely decided value according to the predetermined function (the specified function). Specifically, the step S13 activates the check data generation circuit to implement the conversion of the retrieved file management information into the check data. The check data is referred to as the reference check data.

A step S14 following the step S13 compares the read-out check data with the reference check data, and gets the result of the comparison.

A step S15 subsequent to the step S14 refers to the comparison result provided by the step S14. The step S15 decides whether or not the comparison result indicates that the read-out check data is equal to the reference check data. When the comparison result indicates that the read-out check data is equal to the reference check data, the program advances to a step S16. On the other hand, when the comparison result indicates that the read-out check data is different from the reference check data, the program advances to a step S17.

The step S16 concludes that the file or the file group in the removable recording medium has not been altered. Preferably, the step S16 sets a flag for the file or the file group to a state indicating that the file or the file group has not been altered. After the step S16, the current execution cycle of the program segment ends.

The step S17 concludes that the file or the file group in the removable recording medium has been altered. Preferably, the step S17 sets the flag for the file or the file group to a state indicating that the file or the file group has been altered. The step S17 may write the reference check data over the current check data in the specified area of the removable recording medium. This action means updating the check data in the removable recording medium into consistency with the file management information therein and with the contents of the file or file group therein. After the step S17, the current execution cycle of the program segment ends.

In the embodiment of this invention, file management information is obtained which indicates the present conditions of a file or a file group in a removable recording medium. Usually, the file management information is read out from the removable recording medium. According to the predetermined function, the obtained file management information is converted into check data representative of a uniquely decided value. Normally, the check data reflects the present conditions of the file or the file group in the removable recording medium. The check data is recorded on the specified area in the removable recording medium. The check data in the removable recording medium is out of the management by the file system.

It is assumed that the removable recording medium which stores the check data is ejected from the drive in the present apparatus, and is then inserted into a drive in another apparatus (a second apparatus). In the case where the file or the file group in the removable recording medium is rewritten, updated, or deleted by the second apparatus, or in the case where a new file is recorded on the movable recording medium by the second apparatus, the check data in the removable recording medium goes inconsistent with the recorded contents of the file or the file group. On the other hand, in the second apparatus, the file management information in the removable recording medium is updated as the file or the file group therein is rewritten, updated, or deleted, or when a new file is recorded thereon.

When the removable recording medium is inserted into the drive of the present apparatus, the file management information is retrieved from the file-system management area in the removable recording medium. According to the predetermined function, the retrieved file management information is converted into check data representative of a uniquely decided value. The check data is referred to as the reference check data. Meanwhile, the check data is read out from the specified area in the removable recording medium. The read-out check data is compared with the reference check data to get a result of the comparison.

When the comparison result indicates that the read-out check data is different from the reference check data, it is concluded that the file or the file group in the removable recording medium has been altered. In this case, the current check data in the specified area of the removable recording medium is updated into agreement with the reference check data, being made consistent with the recorded contents of the file or the file group in the removable recording medium. On the other hand, when the comparison result indicates that the read-out check data is equal to the reference check data, it is concluded that the file or the related file group in the removable recording medium has not been altered. In this case, the current check data in the specified area of the removable recording medium is held the same.

It is possible to quickly detect alteration of the recorded contents of a file or a file group in a removable recording medium independently of the file size or the file group size. Furthermore, it is possible to quickly decide whether or not check data in the specified area of a removable recording medium should be updated into consistency with the recorded contents of a file or a file group in the removable recording medium.

The embodiment of this invention uses a FAT (File Allocation Table) file system such as FAT12, FAT16, or FAT32.

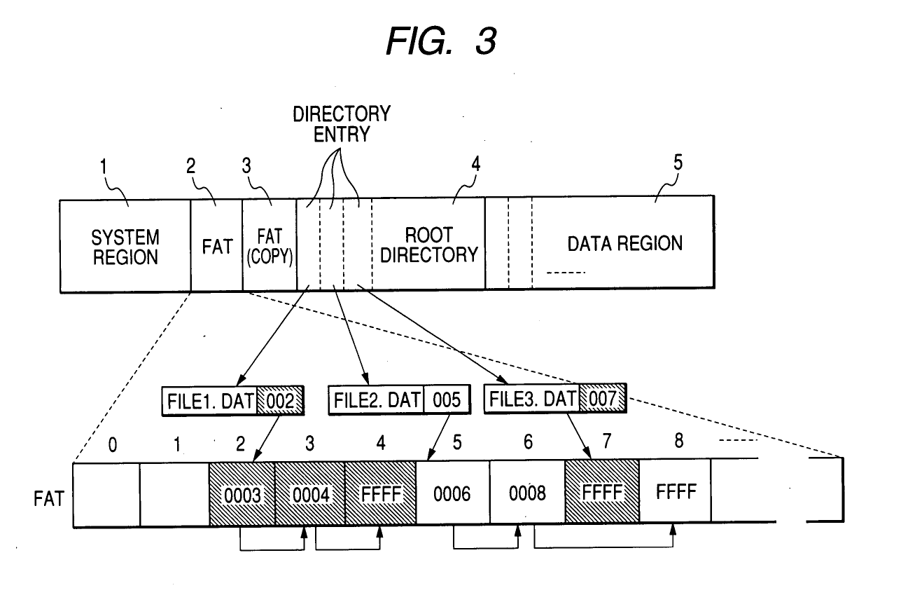

FIG. 3 shows the structure of the FAT file system. As shown in FIG. 3, the FAT file system is composed of a system region 1, a FAT region 2, a FAT region 3, a root directory region 4, and a data region 5. In general, the system region 1, the FAT regions 2 and 3, and the root directory region 4 compose a file-system management area.

When used, the data region 5 is divided into clusters each having successive sectors. A FAT is a management table having entries in one-to-one correspondence with the clusters in the data region 5. Allocation information about a file or a group of files (a file group) is managed by use of the FAT. The FAT is provided in not only the FAT region 2 but also the FAT region 3. The FAT region 2 is normally used while the FAT region 3 is reserved. The FAT region 3 is a copy of the FAT region 2. The clusters in the data region 5 are sequentially given serial address numbers (cluster numbers).

The system region 1 stores an operating system's boot code and basic file system information (file system management information). Data recorded on the data region 5 is in a file or files belonging to directories in a tree-like hierarchical arrangement. The first or highest one of the directories is the root directory while the others are the subdirectories. The root directory region 4 has a directory table which stores information about files and directories in the root directory.

Each of the subdirectories is represented by a special type of a file, that is, a directory table. The structure of the root directory and the structures of the subdirectories are similar. The directory table for the root directory lists directory entries assigned to the respective files and directories in the root directory. Similarly, the directory table for each subdirectory lists directory entries assigned to respective files and directories in the related subdirectory. Each directory entry stores information about the conditions of recorded data in the related file or directory, for example, information about the file/directory's name, the date and time of the creation or latest updating of the related file or directory, the attributes of the related file or directory, and the size of the related file or directory. The attributes of the related file or directory indicate whether the read-out, writing, and execution of the related file or directory should be allowed or inhibited. Each directory entry also stores information about the address (the cluster number) of the first cluster of the file/directory's recorded data. The address information stored in the directory entry is referred to as the entry information.

In this way, each directory stores file management information for each file which includes entry information about the file and condition information representing the date and time of the creation or latest updating of the file, the size of the file, and the attributes of the file. The attributes of the file indicate whether the read-out, writing, and execution of the file should be allowed or inhibited.

Actual data in a typical file is distributed among different clusters in the data region 5. In this case, the file's data (the file data) is in a cluster chain.

The FAT is a table of cluster numbers, that is, a list of cluster entries representing respective cluster numbers. As shown in FIG. 3, each cluster entry records the address (the cluster number) of the next cluster in a chain to indicate the conditions of the connection between portions of file's data (file data). Thus, it is possible to manage the cluster chain, that is, the connection between portions of file's data which are placed in different clusters respectively. A cluster entry corresponding to the final cluster for the related file records a predetermined final-cluster identifier (for example, “FFFF” in FAT16) or a special end-of-file (EOF) character indicating the end of the related chain. It should be noted that the cluster entries shown in FIG. 3 are those in FAT16.

According to the FAT file system, files are managed by use of directories and a FAT as mentioned above.

In the event that a cluster is found to have a faulty sector, a special identifier indicating that the cluster can not be used is recorded on a related cluster entry in the FAT. Thus, the cluster continues to be unused thereafter. Even when only one among sectors composing a cluster is faulty, the whole of the cluster is unused. Thus, clusters tend to be less efficiently used as cluster sizes increase.

The cluster entries in the FAT represent the respective cluster numbers (the respective cluster addresses). Thus, the greatest number of clusters the FAT file system can handle is decided by the number of bits assigned to each cluster entry. As previously indicated, the FAT file system is FAT12, FAT16, or FAT32. The numerals in FAT12, FAT16, and FAT32 denote the number of bits assigned to each cluster entry (or each cluster number). In FAT12, 12 bits are assigned to each cluster number. In FAT16, 16 bits are assigned to each cluster number. In FAT32, 32 bits are assigned to each cluster number. The greatest number of clusters FAT12 can handle is theoretically equal to about 2¹². The greatest number of clusters FAT16 can handle is theoretically equal to about 2¹⁶. The greatest number of clusters FAT32 can handle is theoretically equal to about 2³². Since there are reserved cluster numbers, the greatest number of clusters FAT12, FAT16, or FAT32 can actually handle is slightly smaller than the above-indicated limit value.

As understood from the above description, the root directory region 4 records file management information of the given format (the directory-entry-based format). For each file or directory, the file management information represents the conditions of the file or directory such as the file/directory's name, the date and time of the creation or latest updating of the file or directory, the attributes of the file or directory, the size of the file or directory, and the address (the cluster number) of the first cluster of the file/directory's recorded data. The FAT region 2 records file management information of the given format (the cluster-entry-based format) which includes file allocation information, that is, cluster chain information.

In the embodiment of this invention, check data is generated with respect to file management information recorded on a removable recording medium. In the case of the FAT file system, check data is generated with respect to directories (directory tables). Check data may also generated with respect to a FAT. Regarding the FAT, the generated check data relates to at least information about the directories. When the directory structure (the directory arrangement) is deep, a relatively long time is taken to check all the directories (the directory tables). Thus, in this case, it is preferable to generate check data with respect to not only the directories (the directory tables) but also the FAT. As will be mentioned later, the check data relating to the FAT allows quick detection of alteration of file data.

By referring to only the FAT, it is difficult to detect that a portion of a file in the removable recording medium has been rewritten. Thus, it is preferable to use check data concerning the FAT together with check data concerning the directories. To check whether or not a file group (or a file) in the removable recording medium has been altered, read-out check data concerning the FAT is compared with corresponding reference check data as a first step. When the read-out check data concerning the FAT is equal to the corresponding reference check data, read-out check data concerning the directories is compared with corresponding reference check data as a second step for a confirmation purpose.

Some of examples of alteration of a file or a file group in a removable recording medium are as follows. A new file is made before being recorded on the removable recording medium. A file is deleted from the removable recording medium. A file in the removable recording medium is changed in size. These examples of alteration of the file or the file group cause changes in the contents of the FAT. Accordingly, the examples of alteration of the file or the file group can be detected by comparing read-out check data concerning the FAT with corresponding reference check data before comparing read-out check data concerning the directories with corresponding reference check data. The directory tables may be scattered over the removable recording medium while the FAT is located in the specified region (the FAT region 2 or 3). Therefore, an access to the FAT can be implemented faster than an access to the directory tables. The faster access to the FAT results in quick detection of alteration of the file or the file group in the removable recording medium.

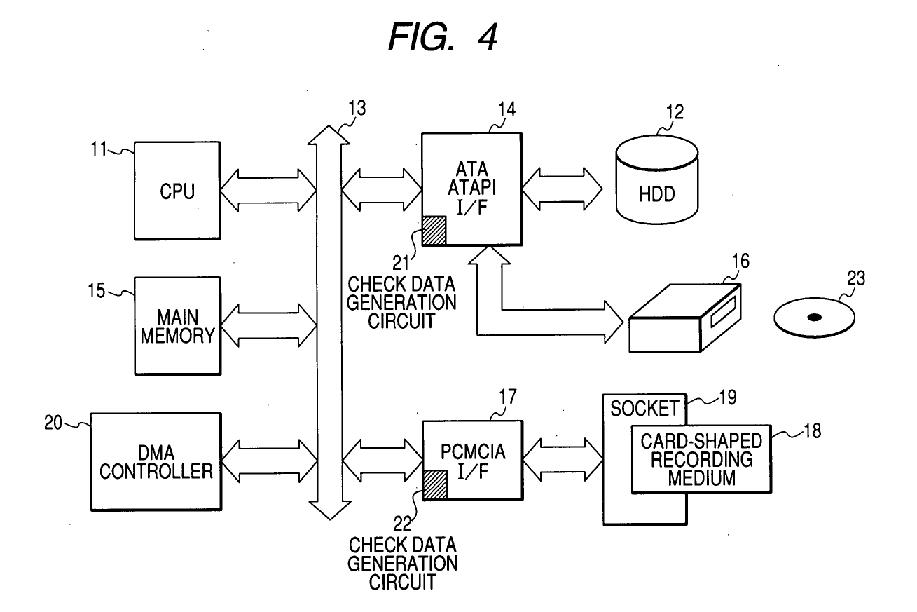

FIG. 4 shows the computer apparatus or the computer-based AV apparatus in the embodiment of this invention. The apparatus of FIG. 4 is also referred to as the present apparatus. The apparatus of FIG. 4 includes a CPU 11, a hard disk drive (HDD) 12, a main bus 13, an ATA/ATAPI interface 14, a main memory 15, a recording-medium drive 16 for a first removable recording medium 23, a PCMCIA interface 17, a PC card socket 19 for a second removable recording medium 18, a DMA controller 20, and check data generation circuits 21 and 22.

The CPU 11, the ATA/ATAPI interface 14, the main memory 15, the PCMCIA interface 17, and the DMA controller 20 are connected via the main bus 13. The hard disk drive 12 and the recording-medium drive 16 are connected with the ATA/ATAPI interface 14. The PC card socket 19 is connected with the PCMCIA interface 17. The check data generation circuits 21 and 22 are provided in the ATA/ATAPI interface 14 and the PCMCIA interface 17, respectively. The first removable recording medium 23 uses a writable recording medium such as a DVD-R, a DVD+R, a DVD-RW, a DVD+RW, a CD-R, or a CD-RW. The first removable recording medium 23 can be inserted into and ejected from the recording-medium drive 16 therefor. The recording-medium drive 16 can write and read data on and from the first removable recording medium 23 placed therein. The second removable recording medium 18 uses a card-shaped writable recording medium such as a memory card or a card-shaped hard disk drive. The second removable recording medium 18 can be inserted into and ejected form the PC card socket 19. When the PC card socket 19 properly holds the second removable recording medium 18, data can be written on and read from the second removable recording medium 18.

The hard disk drive 12 contains a recording medium loaded with machine-code instructions composing a computer program. The machine-code instructions are transferred from the recording medium within the hard disk drive 12 to the main memory 15 via the ATA/ATAPI interface 14 and the main bus 13. The machine-code instructions in the main memory 15 are sequentially executed by the CPU 11 so that the computer program composed of the machine-code instructions will control operation of the present apparatus. The computer program has the first and second segments in FIGS. 1 and 2.

The DMA controller 20 supports the transfer of data among the ATA/ATAPI interface 14, the main memory 15, the PCMCIA interface 17, and other devices (not shown) along paths bypassing the CPU 11. The data transfer supported by the DMA controller 20 is utilized when a great amount of data is required to be transmitted.

Contents data can be transferred from a suitable device (not shown) to the second removable recording medium 18 in the PC card socket 19 via an interface (not shown), the main bus 13, and the PCMCIA interface 17 before being recorded on the second removable recording medium 18. The contents data may be stored in the main memory 15 before being transferred therefrom to the second removable recording medium 18. The contents data may be processed before being transferred to the second removable recording medium 18.

Recorded contents data can be reproduced from the second removable recording medium 18 in the PC card socket 19. The reproduced contents data can be transferred to a suitable device (not shown) via the PCMCIA interface 17, the main bus 13, and an interface (not shown). The reproduced contents data may be stored in the main memory 15 before being transferred therefrom to the suitable device. The reproduced contents data may be processed before being transferred to the suitable device.

Contents data can be transferred from a suitable device (not shown) to the first removable recording medium 23 in the recording-medium drive 16 via an interface (not shown), the main bus 13, and the ATA/ATAPI interface 14 before being recorded on the first removable recording medium 23. The contents data may be stored in the main memory 15 before being transferred therefrom to the first removable recording medium 23. The contents data may be processed before being transferred to the first removable recording medium 23.

Recorded contents data can be reproduced from the first removable recording medium 23 by the recording-medium drive 16. The reproduced contents data can be transferred from the recording-medium drive 16 to a suitable device (not shown) via the ATA/ATAPI interface 14, the main bus 13, and an interface (not shown). The reproduced contents data may be stored in the main memory 15 before being transferred therefrom to the suitable device. The reproduced contents data may be processed before being transferred to the suitable device.

The check data generation circuit 21 in the ATA/ATAPI interface 14 can be fed with file management information. The check data generation circuit 21 performs calculations according to a predetermined function to convert the file management information into check data representative of a uniquely decided value. The check data generation circuit 21 sends the check data to the CPU 11.

Similarly, the check data generation circuit 22 in the PCMCIA interface 17 can be fed with file management information. The check data generation circuit 22 performs calculations according to a predetermined function to convert the file management information into check data representative of a uniquely decided value. The check data generation circuit 22 sends the check data to the CPU 11.

The computer program may be designed to enable the CPU 11 to serve as the check data generation circuits 21 and 22. In this case, the check data generation circuits 21 and 22 are omitted from the ATA/ATAPI interface 14 and the PCMCIA interface 17.

The check data generation circuits 21 and 22 in the ATA/ATAPI interface 14 and the PCMCIA interface 17 can generate check data simultaneously with the transfers of data or information through the ATA/ATAPI interface 14 and the PCMCIA interface 17. In the case where the CPU 11 serves as the check data generation circuits 21 and 22, the CPU 11 generates check data therein so that a step of sending check data to the CPU 11 is unnecessary.

It should be noted that the ATA/ATAPI interface 14 and the PCMCIA interface 17 may be replaced by other interfaces having the function of writing and reading data in and from a recording medium. Examples of these interfaces are SCSI interfaces, USB interfaces, and IEEE1394 interfaces.

When the present apparatus records contents data on the first removable recording medium 23 in the recording-medium drive 16 or the second removable recording medium 18 in the PC card socket, the present apparatus also records application management information thereon. The application management information means information which is useful for an application peculiar to the present apparatus at the time of use of the contents data.

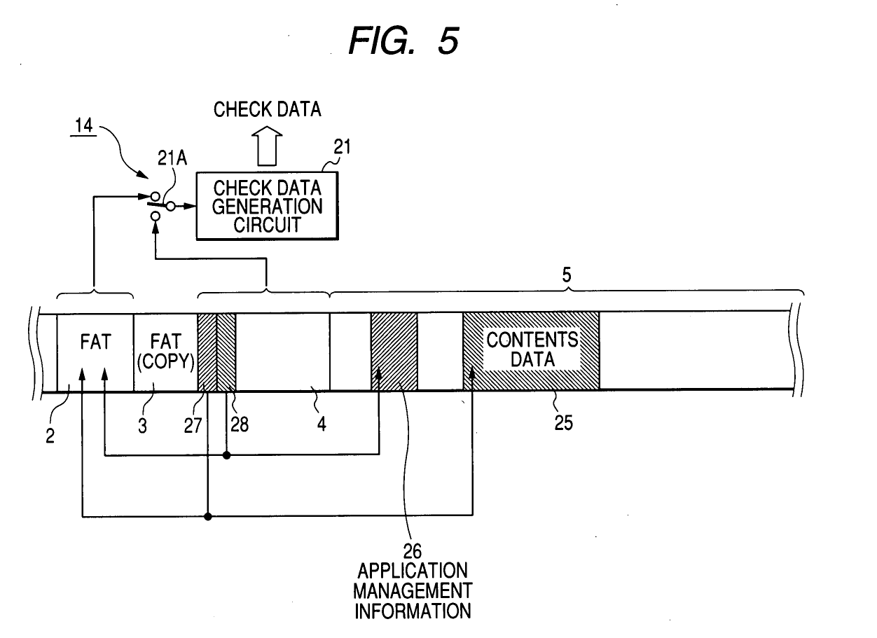

Specifically, as shown in FIG. 5, contents data 25 and application management information 26 are recorded on the data region 5 in the currently-accessed removable recording medium 18 or 23 as file data. The present apparatus generates file management information 27 for the contents data 25, and file management information 28 for the application management information 26. The file management information 27 and the file management information 28 are of the format matching with the root directory region 4 in the removable recording medium 18 or 23. The file management information 27 and the file management information 28 are contained in a root directory newly generated by the present apparatus. In addition, the present apparatus generates file management information “A” for the contents data 25, and file management information “B” for the application management information 26. The file management information “A” and the file management information “B” are of the format matching with the FAT region 2. Each of the file management information “A” and the file management information “B” includes file allocation information (cluster chain information). The file management information “A” and the file management information “B” are contained in a FAT newly generated by the present apparatus. The root directory and the FAT are written into the root directory region 4 and the FAT region 2 in the currently-accessed removable recording medium 18 or 23, respectively. At that time, the present apparatus records the file management information 27 and the file management information 28 on the root directory region 4 in the currently-accessed removable recording medium 18 or 23, and records the file management information (the cluster chain information) “A” and the file management information (the cluster chain information) “B” on the FAT region 2 in the currently-accessed removable recording medium 18 or 23. Each of the file management information 27, the file management information 28, the file management information “A”, and the file management information “B” includes at least one of information pieces inherent in the related file (the file of the contents data 25 or the file of the application management information 26), for example, an information piece representing the allocation of the file, an information piece representing the date of the creation or latest updating of the file, and an information piece representing the size of the file.

In the embodiment of this invention, check data (referred to as directory check data) is generated from the file management information 27 and the file management information 28 during the writing of the root directory into the currently-accessed removable recording medium 18 or 23. Specifically, the file management information 27 and the file management information 28 in the root directory directed toward the root directory region 4 in the currently-accessed removable recording medium 18 or 23 are fed to the check data generation circuit 21 or 22 before the check data generation circuit 21 or 22 generates the directory check data from the file management information 27 and the file management information 28 by using the predetermined function. In other words, when the root directory is written into the currently-accessed removable recording medium 18 or 23, the check data generation circuit 21 or 22 is activated to generate the directory check data. Upon the end of the writing of the root directory, the check data generation circuit 21 or 22 sends the generated directory check data to the CPU 11. Then, the CPU 11 operates to write the directory check data in a specified area of the currently-accessed removable recording medium 18 or 23. Preferably, the specified area is out of the management by the FAT file system.

In the embodiment of this invention, check data (referred to as FAT check data) is generated from the file management information “A” and the file management information “B” during the writing of the FAT into the currently-accessed removable recording medium 18 or 23. Specifically, the file management information “A” and the file management information “B” in the FAT directed toward the FAT region 2 in the currently-accessed removable recording medium 18 or 23 are fed to the check data generation circuit 21 or 22 before the check data generation circuit 21 or 22 generates the FAT check data from the file management information “A” and the file management information “B” by using the predetermined function. In other words, when the FAT is written into the currently-accessed removable recording medium 18 or 23, the check data generation circuit 21 or 22 is activated to generate the FAT check data. Upon the end of the writing of the FAT, the check data generation circuit 21 or 22 sends the generated FAT check data to the CPU 11. Then, the CPU 11 operates to write the FAT check data in the specified area of the currently-accessed removable recording medium 18 or 23.

Directory check data can be generated after the writing of a root directory into the removable recording medium 18 or 23. Similarly, FAT check data can be generated after the writing of a FAT into the removable recording medium 18 or 23.

With reference to FIG. 5, the ATA/ATAPI interface 14 includes a switch 21A in addition to the check data generation circuit 21. The switch 21A is connected with the check data generation circuit 21. The switch 21A can be changed between a first position and a second position by the CPU 11. When the generation of the FAT check data is required, the switch 21A is set to its first position at which the file management information (the cluster chain information) “A” and the file management information (the cluster chain information) “B” are transmitted from the FAT region 2 to the check data generation circuit 21. In this case, the check data generation circuit 21 is instructed by the CPU 11 to generate the FAT check data from the file management information “A” and the file management information “B”. On the other hand, when the generation of the directory check data is required, the switch 21A is set to its second position at which the file management information 27 and the file management information 28 are transmitted from the root directory region 4 to the check data generation circuit 21. In this case, the check data generation circuit 21 is instructed by the CPU 11 to generate the directory check data from the file management information 27 and the file management information 28.

The PCMCIA interface 17 includes a switch connected with the check data generation circuit 22 which is similar to the switch 21A in the ATA/ATAPI interface 14. Thus, when the generation of the FAT check data is required, the switch is set to its first position at which the file management information (the cluster chain information) “A” and the file management information (the cluster chain information) “B” are transmitted from the FAT region 2 to the check data generation circuit 22. In this case, the check data generation circuit 22 is instructed by the CPU 11 to generate the FAT check data from the file management information “A” and the file management information “B”. On the other hand, when the generation of the directory check data is required, the switch is set to its second position at which the file management information 27 and the file management information 28 are transmitted from the root directory region 4 to the check data generation circuit 22. In this case, the check data generation circuit 22 is instructed by the CPU 11 to generate the directory check data from the file management information 27 and the file management information 28.

It should be noted that check data may be generated for every information managing the file system, and individual management may be implemented. Alternatively, first information managing the file system and second information managing the file system may be handled as check object information in one file before the generation of check data from the one-file check object information.

Preferably, the check data (the FAT check data and the directory check data) is designed to enable reliable detection of alteration of file data in the file system. In the embodiment of this invention, the predetermined function used for converting the file management information into the check data is a one-way function such as a hash function.

A hash function compresses an arbitrary-length message into a given-length message. Even a slight change in input message data to the hash function is expected to always cause a variation in an integer represented by output message data therefrom. It is difficult that an inverse transformation of output message data reproduces original input message data to the hash function. Therefore, the hash function is advantageous in preventing the recovery of the original data (the file management information) from the check data.

It should be noted that check data may be generated by a simple calculation using a cyclic redundancy check (CRC) code. When a polynomial identical with that frequently employed in a file system is used for the CRC code, it is unnecessary to support a plurality of different calculations. Thus, use of such a polynomial provides a convenient result. An example of the polynomial is a 16-bit one expressed as follows.
X¹⁶+X¹²+X⁵+1
The above-indicated polynomial is used to check a descriptor in UDF (Universal Disk Format), and is prescribed in ITU-TV.41. The above-indicated polynomial is also the same as that used to generate CRC data for detecting errors in main data transferred by a UDMA mode in an ATA/ATAPI interface. At the time of UDMA data transfer, an initial value of the CRC code is given. In the case where the initial value and the polynomial for the CRC code to generate the check data are the same as those for the CRC code to generate the CRC data for detecting errors in the main data transferred by the UDMA mode, the structure for generating the check data and the structure for generating the CRC data can be in common.

Preferably, each of the file management information 27 and the file management information 28 has 512 bytes. In this case, the calculation for generating the related check data can be performed during the data transfer. In FIG. 5, the size of the root directory region 4 corresponds to “n” sectors where “n” denotes a given natural number and each sector has 512 bytes. It should be noted that each of the file management information “A” and the file management information “B” may have a given number of bytes, for example, 512 bytes.

When file management information (at least one of the file management information 27, the file management information 28, the file management information “A”, and the file management information “B”, or a combination of two or more of them) is assigned to a plurality of sectors (1 sector: 512 bytes), it is preferable to generate check data on an extent-by-extent basis where “extent” means a set of successive sectors. In this case, a high efficiency is attained since the generation of check data can be implemented for each necessary access to an extent.

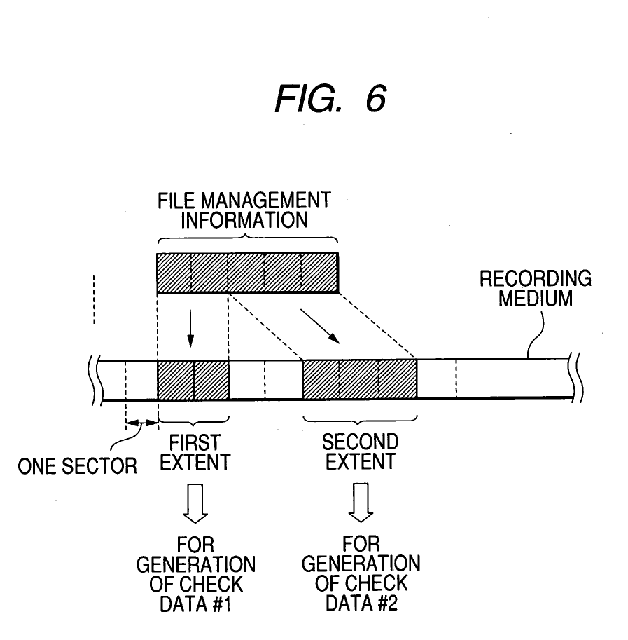

FIG. 6 shows an example of the above-mentioned conditions. With reference to FIG. 6, file management information (at least one of the file management information 27, the file management information 28, the file management information “A”, and the file management information “B”, or a combination of two or more of them) is assigned to 5 sectors, and is recorded on two separate extents in the removable recording medium 18 or 23. The first extent, that is, first one of the two extents, has 2 successive sectors. The second extent or the other extent has 3 successive sectors. A reading command is set for each of the extents. Accordingly, it is preferable to prepare a structure for enabling check data to be utilized each time read-out is carried out. In this case, the check data can be obtained simultaneously with the end of an access to an extent. In FIG. 6, a first portion of the 5-sector file management information is recorded on the first extent (the 2-sector extent) while a second portion thereof is recorded on the second extent (the 3-sector extent). Check data #1 is generated from the first portion of the 5-sector file management information which exists in the first extent. Check data #2 is generated from the second portion of the file 5-sector management information which exists in the second extent.

The check data generated in this way is recorded on a specified area in the removable recording medium 18 or 23 which differs from a recording-medium area assigned to general data managed by the file system. This design provides the following advantages. Since the recorded check data is invisible or undetectable to a user and the file system, it is possible to prevent the recorded check data from being carelessly changed. Preferably, the check data is recorded on a specified place in the final session of the removable recording medium 18 or 23. In this case, alteration of file data by another apparatus which neither generates nor records check data can be detected by merely determining whether the check data is present in or absent from the removable recording medium 18 or 23.

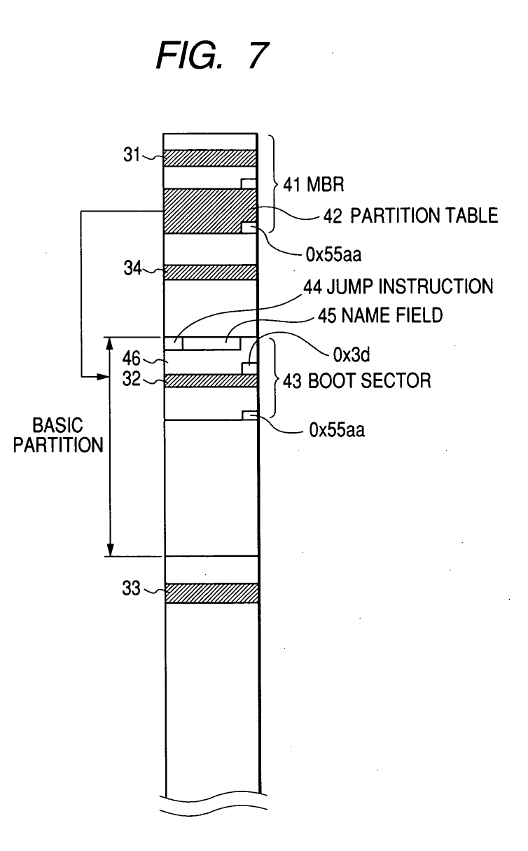

Examples of the specified area in the removable recording medium 18 or 23 which stores the check data will be explained below. As shown in FIG. 7, the removable recording medium 18 or 23 has specified areas 31, 32, 33, and 34 assigned to the check data. The specified areas 31, 32, 33, and 34 are also referred to as the check data recording areas 31, 32, 33, and 34.

The check data recording area 31 extends in an MBR (master boot record) region 41 of the hard disk, that is, the removable recording medium 18. In the MBR region 41, the last two bytes are assigned to a magic number (a fixed value “0x55aa”), and a set of 64 successive bytes which immediately precede the last two bytes are assigned to a partition table 42. The check data recording area 31 is at least a part of the MBR region 41 except the last two bytes and the partition-table bytes.

The check data recording area 32 extends in a boot sector 43 of the hard disk, that is, the removable recording medium 18. According to the FAT file system, a jump instruction is written in the first three bytes 44 in the boot sector 43 when a boot code exists. Windows 95/98 (registered trademarks) may rewrite eight name-field bytes 45 subsequent to the first three bytes 44 in the boot sector 43 when the removable recording medium is mounted. In the boot sector 43, a subsequent portion 46 up to a position “0x3d” is assigned to the parameters of the FAT file system, and the last two bytes are assigned to a magic number (a fixed value “0x55aa”). The check data recording area 32 is at least a part of the boot sector 43 except the first three bytes 44, the eight name-field bytes 45, the parameter portion 46, and the last two bytes.

The check data recording area 33 extends in a space or a gap between partitions of the hard disk, that is, the removable recording medium 18. Specifically, the check data recording area 33 extends in an exclusive zone preceding or following a partition.

The check data recording area 34 uses at least one of hidden sectors which can be set by the FAT file system. Sectors designated by hidden sector count are the first one to the last one immediately preceding the boot sector 43.

Preferably, the check data is stored in at least one of the check data recording areas 31, 32, 33, and 34.

An explanation will be given of the case where the removable recording medium 18 or 23 is moved from the present apparatus to a PC (a personal computer). According to the de facto standard FAT file system, the PC can access the two files, that is, the contents data 25 and the application management information 26 in the removable recording medium 18 or 23. It is assumed that the PC does not know an application relating to the contents data 25. When the PC deletes or updates the contents data 25, the application management information 26 goes inconsistent with the resultant contents data 25. The PC updates the file management information 27 and the cluster chain information “A” in accordance with the deletion or updating of the contents data 25. The updated file management information 27 and the updated cluster chain information “A” move out of harmony with the check data in the removable recording medium 18 or 23. When the PC writes a new file in the removable recording medium 18 or 23 in connection with the application management information 26, the contents of the new file are inconsistent with the application management information 26. The PC updates the file management information 27 and the cluster chain information “A” in accordance with the writing of the new file. The updated file management information 27 and the updated cluster chain information “A” move out of harmony with the check data in the removable recording medium 18 or 23.

Thus, upon the deletion or updating of the contents data 25 by the PC or upon the writing of a new file by the PC, the application management information 26 goes inconsistent with the resultant contents data 25 while the file management information 27 and the cluster chain information “A” move out of harmony with the check data in the removable recording medium 18 or 23. Accordingly, the inconsistency between the application management information 26 and the resultant contents data 25 can be detected on the basis of the disharmony between the file management information (the file management information 27 and the cluster chain information “A”) and the check data in the removable recording medium 18 or 23. In the event that the contents data 25 and the application management information 26 are inconsistent with each other, it is pointless to use the application management information 26 as it is.

In the case where the removable recording medium 18 or 23 is moved back to the present apparatus from the PC thereafter, the present apparatus examines the harmony between the file management information and the check data in the removable recording medium 18 or 23. The examination is to detect whether or not the file data in the removable recording medium 18 or 23 has been altered, and also whether or not the contents data 25 and the application management information 26 are inconsistent with each other. When it is detected that the contents data 25 and the application management information 26 are inconsistent with each other, the present apparatus updates the application management information 26 into consistency with the contents data 25. As a result, the contents data 25 can be prevented from being operated in accordance with the “wrong” application management information 26. Thus, the contents data 25 can be protected. When it is detected that the file data in the removable recording medium 18 or 23 has been altered, the present apparatus updates the check data in the removable recording medium 18 or 23 into harmony with the file management information therein.

Specifically, when the removable recording medium 18 or 23 is moved back to the present apparatus from the PC, the present apparatus reads out the check data from the specified area in the removable recording medium 18 or 23. The present apparatus stores the read-out check data in the internal memory, for example, the main memory 15. The present apparatus reads out the FAT and the root directory from the removable recording medium 18 or 23. The present apparatus converts the file management information 27, the file management information 28, the file management information “A”, and the file management information “B” in the read-out FAT and the read-out root directory into the reference check data in the previously-mentioned way. The present apparatus compares the read-out check data in the internal memory with the reference check data.

It should be noted that the read-out of the FAT and the root directory from the removable recording medium 18 or 23 may precede the read-out of the check data therefrom. In this case, the present apparatus generates the reference check data before storing the reference check data in the internal memory. Then, the present apparatus performs the read-out of the check data from the removable recording medium 18 or 23. Subsequently, the present apparatus compares the read-out check data with the reference check data in the internal memory.

When the read-out check data is equal to the reference check data, it is concluded that the file data in the removable recording medium 18 or 23 has not been altered. In this case, the present apparatus shifts to a stand-by mode of operation. On the other hand, when the read-out check data is different from the reference check data, it is concluded that the file data in the removable recording medium 18 or 23 has been altered. At the same time, it is also concluded that the contents data 25 and the application management information 26 are inconsistent with each other. In this case, the present apparatus reconstructs and updates the application management information 26 into consistency with the contents data 25. Furthermore, the present apparatus updates the check data in the removable recording medium 18 or 23 into agreement with the reference check data. In other words, the present apparatus harmonizes the check data in the removable recording medium 18 or 23 with the file management information therein.

The absence of the check data from the removable recording medium 18 or 23 causes the read-out check data to be different from the reference check data. The absence of the check data from the removable recording medium 18 or 23 means that the removable recording medium 18 or 23 has never been used by the present apparatus or other apparatuses capable of generating and recording check data. In this case, not only the check data but also the application management information 26 is absent from the removable recording medium 18 or 23. Preferably, upon the mounting of the removable recording medium 18 or 23, the present apparatus detects whether or not the removable recording medium 18 or 23 has never been used by the present apparatus or other apparatuses capable of generating and recording check data. When it is detected that the removable recording medium 18 or 23 has never been used by the present apparatus or other apparatuses capable of generating and recording check data, the present apparatus avoids executing an unnecessary later action (newly generating the application management information 26 or reconstructing the application management information 26).

The present apparatus may generate an identifier which indicates that the present apparatus has recorded the check data on the specified area in the removable recording medium 18 or 23. The present apparatus records information inclusive of the identifier on the removable recording medium 18 or 23. Upon the mounting of the removable recording medium 18 or 23, the present apparatus accesses the information inclusive of the identifier therein to decide whether the identifier is present or absent. When the identifier is absent, the present apparatus concludes that the removable recording medium 18 or 23 has never been used by the present apparatus or other apparatuses capable of generating and recording check data. In the removable recording medium 18 or 23, the recorded information inclusive of the identifier is outside the area under the management by the file system. Alternatively, the recorded information inclusive of the identifier may be a file within the area under the management by the file system. Preferably, the recorded information inclusive of the identifier is in the specified area storing the check data. In this case, the present apparatus can access the information inclusive of the identifier when reading out the check data from the removable recording medium 18 or 23. Thus, the present apparatus can promptly detect that the removable recording medium 18 or 23 has never been used by the present apparatus or other apparatuses capable of generating and recording check data.

Preferably, the check data is of a given format as indicated below. The given format is designed so that the check data will relate to information about the extent in which the corresponding file management information is placed. In this case, it is possible to promptly detect the place in the removable recording medium 18 or 23 which stores the file management information used to generate the check data.

Preferably, one complete piece of check data has a set of a portion “CheckData”, a portion “StartLBA”, and a portion “ExtentSize”. The portion “CheckData” is pure check data. The portion “StartLBA” denotes the logical block address (LBA) of the first sector in the extent which stores the file management information used to generate the pure check data. The portion “ExtentSize” denotes the size of the extent which is measured in LBA.

In the case where there are plural complete pieces of check data, they are recorded on the removable recording medium 19 or 23 while being sequentially arranged.

An example of the recording format for the check data is as follows.

struct BFSI {

| | | |
|---|---|---|
| Base_FileSystem_ID | 2 byte | WORD |
| reserved[1] | 1 byte | BYTE |
| Partition_Table_Offset | 1 byte | BYTE |
| Partition_Table_LBA | 4 byte | DWORD |
| Extended_Partition_Table_LBA | 4 byte | DWORD |
| reserved[4] | 1*4 byte | BYTE |
| PartitionTable | 16 byte | PTable |
| FileSystem_Implementation_Use( ) | variable | FSIU |

}

The portion “Base_FileSystem_ID” is an ID for identifying a file system being an object. Any one of different fixed values is assigned to the “Base_FileSystem_ID” so that FAT12, FAT16, FAT32, and other file systems can be distinguished from each other. The portions “reserved” are reserved areas properly inserted to attain an alignment of the data structure. The portion “Partition_Table_Offset” denotes a value of “0”, “1”, “2”, or “3” for identifying four partitions in the partition table area. The portion “Partition_Table_LBA” denotes the LBA of the logical sector on which the partition table is recorded. The portion “Extended_Partition_Table_LBA” is an area prepared for a future extension. The portion “PartitionTable” is information about a table loaded with the allocation of a partition being an object. The table information “PartitionTable” is a copy of the partition table information which is referred to by “Partition_Table_Offset” in “Partition_Table_LBA”. In the case where the removable recording medium 18 or 23 has a plurality of partitions, the check data can be managed for each of the partitions.

The portion “FileSystem_Implementation_Use( ): FSIU” denotes the contents of check data which are prescribed for each file system. A way of managing files varies from file system to file system, and hence the prescription for each file system is adopted. In the case of the FAT file system, the contents of check data (the portion “FSIU”) are prescribed as “FileSystem_Implementation_Use_for_FAT( )” indicated below.

FileSystem_Implementation_Use_for_FAT( ) {

| | | |
|---|---|---|
| Number_of_SubDirectory (=NDS) | 4 byte | DWORD |
| reserved[4] | 1*4 byte | DWORD |
| FAT_BPB | variable(*) | FSI |
| FAT_FSInfo | variable(*) | FSI |
| FAT_FAT1 | variable(*) | FSI |
| FAT_FAT2 | variable(*) | FSI |
| FAT_ROOT | variable(*) | FSI |
| FAT_SUB[NSD] | variable(*)*NSD | FSI |

}

where the character (*) normally denotes 32 bytes.

Thus, the portion “FSIU” is substantially composed of a plurality of FSI (FileSystem_Integrity) information pieces and subdirectory number (Number_of_SubDirectory: NSD) information. The letters “NSD” denote the number of subdirectories.

In the above “FileSystem_Implementation_Use_for_FAT( )”, each FSI information piece is extent information corresponding to the check data, and is composed of several elements peculiar to the FAT file system. The portion “FAT_BPB” denotes check data with respect to a bios parameter block. The segment “BPB” corresponds to the previously-mentioned boot sector, and denotes information of the first sector in the FAT file system. The portion “FAT_FSInfo” denotes check data with respect to management information for FAT32. The portion “FAT_FAT1” denotes check data with respect to the FAT. The portion “FAT_FAT2” denotes check data with respect to a copy of the FAT. The portion “FAT_ROOT” denotes check data with respect to the root directory. The portion “FAT_SUB[NSD]” denotes check data with respect to the respective subdirectories, the number of which is represented by “NSD”.

Each FSI information piece has a structure as follows.

struct FileSystem_Integrity {

| | | |
|---|---|---|
| FSI_ID[3] | 1*3 byte | BYTE |
| reserved | 1 byte | BYTE |
| Section_ID | 2 byte | WORD |
| reserved | 4 byte | DWORD |
| reserved | 4 byte | DWORD |
| Number_of_Extent(=NOE) | 4 byte | DWORD |
| Extent_Information[NOE] | 12*NOE byte_EI | |

} FSI;

The portion “FSI_ID” is an identifier for denoting the FSI information piece, and is a sequence of letters “FSI”. The portion “Section_ID” is an identification number for denoting the type of FSI in the present file system. In the case of the FAT file system, the identification number “Section_ID” is prescribed as follows.

| | |
|---|---|
| 0 | invalid entry |
| 1 | FAT1 |
| 2 | FAT2 |
| 3 | BPB |
| 4 | FSINFO |
| 5 | ROOT |

#8000-#FFFE SubDirectory;
   lower 15 bits denote the depth of the subdirectory, and the depth of a subdirectory immediately below the root directory is defined as “0”;
#FFFF No Information

The portion “Number_of_Extent(=NOE)” denotes the number of extents assigned to data (file management information) to be checked. The portion “Extent_Information[NOE]” denotes extent information concerning the data to be checked. When the extent number NOE differs from “1”, there is a set of extent information pieces equal in number to NOE. One complete piece of “Extent_Information” has a set of a portion “CheckData”, a portion “StartLBA”, and a portion “ExtentSize”, and is defined as follows.

struct Extent_Information {

| | | |
|---|---|---|
| Extent_Address | 4 byte | DWORD |
| Extended_Extent_Address | 4 byte | DWORD |
| Extent_Size | 2 byte | WORD |
| CRC16 | 2 byte | WORD |

} _EI;

The portion “Extent_Address” denotes the LBA of the first sector in an extent being an object. The portion “Extended_Extent_Address” is used for an extension such that the LBA has more than 4 bytes. Specifically, the portion “Extended_Extent_Address” is assigned to the higher 4 bytes among the bytes composing the LBA. The portion “Extent_Size” denotes the size of the extent which is measured in sector. The portion “CRC16” denotes the value of the output from a CRC function, that is, the value calculated by applying a polynomial in ITU-TV.41 to the data (the file management information) in the extent. Thus, the portion “CRC16” is check data.

In the case where an initial value for the CRC function (especially, the CRC 16 function, that is, the 16-bit CRC function) uses “Ox4ABA”, the CRC is the same as that defined in UDMA data transfer prescribed by ATA/ATAPI-4 or above. In this case, the embodiment of this invention is suited for use in an apparatus designed to conform to ATA/ATAPI-4.

While the check data is calculated for each extent in the embodiment of this invention, the CRC may be held without being reset for each extent. In this case, even when data being an object (file management information) is separated into plural extents, the object data can be managed by one piece of check data so that an increase in the number of pieces of check data can be suppressed.

In the embodiment of this invention, the FAT file system may be replaced by an NTFS (New Technology File System). The NTFS implements file allocation on a cluster-by-cluster basis as the FAT file system does. The features of the NTFS are as follows. The NTFS less causes fragmentation than the FAT file system. The NTFS system is provided with a scheme for improving reliability. The NTFS system enables attributes to be set more finely. The NTFS system can provide more flexible and higher management of files than that provided by the FAT file system.

The feature of the structure of the NTFS is that fixed-length management records are generated for respective directories and files in a partition, and hence intensive management is implemented. The group of the management records is one file called an MTF (a master file table). Each of the management records is of a fixed length. A small file having a size corresponding to less than the management-record fixed length is stored in a manner such that it is completed within a management record. On the other hand, clusters in an area separate from the MFT are assigned to a great file having a size corresponding to more than the management-record fixed length, and indexes to the clusters are stored in a management record.

In the case of the NTFS, check data is generated with respect to the MFT.

In the embodiment of this invention, the FAT file system may be replaced by an ISO 9660 file system. In this case, check data is generated for each directory. The writing of data into the removable recording medium 18 or 23 is controlled by the ISO 9660 file system rather than the FAT file system. After another apparatus (a second apparatus) which neither generates nor records check data alters file data in the removable recording medium 18 or 23, check data is absent from the newest session. Thus, when the removable recording medium 18 or 23 is mounted on the present apparatus, it is preferable to detect the presence or absence of check data in or from the newest session to decide whether or not file data in the removable recording medium 18 or 23 has been altered by the second apparatus. Accordingly, it is unnecessary to compare the read-out check data with the reference check data. When it is decided that file data in the removable recording medium 18 or 23 has been altered by the second apparatus, the present apparatus carries out necessary processing steps.

In the embodiment of this invention, the FAT file system may be replaced by a UDF file system. In this case, the writing of data into the removable recording medium 18 or 23 is controlled by the UDF file system rather than the FAT file system. According to UDF1.5 or above, the writing of data into a recording medium is implemented by using a management structure based on a VAT (virtual allocation table). After another apparatus (a second apparatus) which neither generates nor records check data alters file data in the removable recording medium 18 or 23, check data is absent from the newest session. Thus, when the removable recording medium 18 or 23 is mounted on the present apparatus, it is preferable to detect the presence or absence of check data in or from the newest session to decide whether or not file data in the removable recording medium 18 or 23 has been altered by the second apparatus. Accordingly, it is unnecessary to compare the read-out check data with the reference check data. When it is decided that file data in the removable recording medium 18 or 23 has been altered by the second apparatus, the present apparatus carries out necessary processing steps.

In the case where the UDF file system is used, it is preferable that check data is generated for each directory and a checking procedure similar to that for the FAT file system is performed. According to the UDF file system, a volume management structure is of a descriptor format. Thus, check data is stored in a recording-medium area except a descriptor sequence and partitions.

In the case of the UDF file system, data to be checked (file management information) is a space bit map, at least one directory, and at least one ICB (information control block). The space bit map corresponds to the FAT in the FAT file system. The space bit map is a table having a bit map indicating which area on the removable recording medium 18 or 23 is used and which area thereon is not used. The bit map is composed of bits each corresponding to one logical sector. Each bit being “0” or “1” indicates whether or not the corresponding logical sector is used. The bit map is changed as the length or the allocation of a file is altered.

The directory and the ICB are file management information. The directory stores identification information of a file or files, and information of the recorded position of the ICB or ICBs. One ICB is prepared for each file. The ICB has information about the attributes of the related file, and information about the allocation of the related file on the removable recording medium 18 or 23. Therefore, the directory and the ICB has information equivalent to that in the directory and the FAT in the FAT file system.

Preferably, the present apparatus first checks the space bit map in the removable recording medium 18 or 23 as first checking the FAT in the FAT file system. Subsequently, the present apparatus checks the directory and the ICB in the removable recording medium 18 or 23. The creation of new file data, the deletion of file data, and the change of file data which causes a change in the file size are types of alteration of file data. These types of alteration of file data change the space bit map. Thus, these types of alteration of file data can be detected at a stage when checking the space bit map has been completed.

In the embodiment of this invention, the FAT file system may be replaced by a bridge file system which allows a file in the removable recording medium 18 or 23 to be accessed by any one of different file systems. In this case, the present apparatus is designed to perform operation steps mentioned hereafter. According to the predetermined function, file management information of a first file system is converted into check data representative of a uniquely decided value. The check data is recorded on the specified area in the removable recording medium 18 or 23. The check data is designed to be accessible by a second file system. In the case where the removable recording medium 18 or 23 is mounted on the present apparatus and the second system file is activated, file management information of the first file system is read out from the removable recording medium 18 or 23. Then, the read-out file management information is converted into reference check data representative of a uniquely decided value according to the predetermined function. Subsequently, recorded check data is read out from the removable recording medium 18 or 23. The read-out check data is compared with the reference check data. When the read-out check data is different from the reference check data, file management information of the second file system in the removable recording medium 18 or 23 is changed to reflect the file management information of the first file system and the recorded check data in the removable recording medium 18 or 23 is updated into agreement with the reference check data. Thereby, the harmonized parallel relation between the first and second file systems is maintained.

In the case where portions of the file management information of the first file system are recorded on respective extents in the removable recording medium 18 or 23, check data is generated from each portion of the file management information. In other words, check data is generated on an extent-by-extent basis. The generated check data and allocation information about the extents are recorded on the removable recording medium 18 or 23 while being made in a correspondence relation.

While the check data is recorded on the specified area in the removable recording medium 18 or 23 which differs from the recording-medium area assigned to general data managed by the file system in the embodiment of this invention, the check data may be recorded on the removable recording medium 18 or 23 as general data handled by the file system. In other words, the check data may be recorded on the data region 5 in the removable recording medium 18 or 23. In this case, the check data in the removable recording medium 18 or 23 can be accessed in the normal way. Preferably, the check data in the removable recording medium 18 or 23 is managed while being given a protective attribute such as “system file”, “read only”, or “hidden”. The protective attribute makes it difficult to alter the check data in the removable recording medium 18 or 23.

While the hash function or the CRC16 function is used to generate the check data in the embodiment of this invention, a CRC function having bits whose number differs from 16 may be used for this purpose. In the embodiment of this invention, the initial value for the CRC function uses “0x4ABA”. The initial value for the CRC function may differ from “0x4ABA”. For example, the initial value for the CRC function may be equal to “0xFFFF”.

1. A method of recording check data on a recording medium having a data region, a management region, and a directory region, the data region being for storing file data, the management region being for storing management data representing which portion of the data region is used by the file data, the directory region being for storing file management information about the file data in the data region, wherein the file data, the management data, and the file management information are governed by a file system, the method comprising the steps of:
converting management data into first check data representative of a uniquely decided value according to a predetermined function;
converting file management information into second check data representative of a uniquely decided value according to the predetermined function; and
recording the first check data and the second check data on a specified area in the recording medium.

2. A method as recited in claim 1, wherein the file system is a FAT file system, and the management region is a FAT region.

3. A method as recited in claim 1, wherein the file system is a UDF file system, and the management region is a space bit map region.

4. A method as recited in claim 1, wherein the specified area includes at least one of (1) a master boot record region, (2) a boot sector, (3) a gap between partitions, and (4) a hidden sector.

5. A method of detecting alteration of file data stored in a recording medium and governed by a file system, wherein file management information about the file data is recorded on the recording medium according to the file system, the method comprising the steps of:
reading out check data from a specified area in the recording medium;
converting the file management information into reference check data representative of a uniquely decided value according to a predetermined function; and
comparing the read-out check data and the reference check data to detect whether or not the file data in the recording medium has been altered.

6. A method as recited in claim 5, wherein the recording medium has a data region, a management region, and a directory region, the data region storing the file data, the management region storing management data representing which portion of the data region is used by the file data, the directory region storing management information about the file data in the data region, wherein the management data in the management region and the management information in the directory region compose the file management information, and wherein the read-out check data has first and second segments;
wherein the converting step comprises converting the management data into a first segment of the reference check data which is representative of a uniquely decided value according to the predetermined function, and converting the management information into a second segment of the reference check data which is representative of a uniquely decided value according to the predetermined function; and
wherein the comparing step comprises comparing the first segment of the read-out check data and the first segment of the reference check data to detect whether or not the file data in the recording medium has been altered.

7. A method as recited in claim 6, wherein the comparing step comprises comparing the second segment of the read-out check data and the second segment of the reference check data to detect whether or not the file data in the recording medium has been altered after the comparison between the first segment of the read-out check data and the first segment of the reference check data.

8. A method as recited in claim 6, wherein the file system is a FAT file system, and the management region is a FAT region.

9. A method as recited in claim 6, wherein the file system is a UDF file system, and the management region is a space bit map region.

10. A method as recited in claim 5, wherein the specified area includes at least one of (1) a master boot record region, (2) a boot sector, (3) a gap between partitions, and (4) a hidden sector.

11. An apparatus for recording check data on a recording medium having a data region, a management region, and a directory region, the data region being for storing file data, the management region being for storing management data representing which portion of the data region is used by the file data, the directory region being for storing file management information about the file data in the data region, wherein the file data, the management data, and the file management information are governed by a file system, the apparatus comprising:
means for converting management data into first check data representative of a uniquely decided value according to a predetermined function;
means for converting file management information into second check data representative of a uniquely decided value according to the predetermined function; and
means for recording the first check data and the second check data on a specified area in the recording medium.

12. An apparatus for detecting alteration of file data stored in a recording medium and governed by a file system, wherein file management information about the file data is recorded on the recording medium according to the file system, the apparatus comprising:
means for reading out check data from a specified area in the recording medium;
means for converting the file management information into reference check data representative of a uniquely decided value according to a predetermined function; and
means for comparing the read-out check data and the reference check data to detect whether or not the file data in the recording medium has been altered.
